(19) United States
(12) Patent Application Publication
(10) Pub. No.: US 2020/0385127 A1
(43) Pub. Date: Dec. 10, 2020

(54) Advanced FuelCell Integration Into Aircraft

(71) Applicant: Gabriel Devault, Santa Cruz, CA (US)

(72) Inventor: Gabriel Devault, Santa Cruz, CA (US)

(21) Appl. No.: 16/798,290

(22) Filed: Feb. 21, 2020

Related U.S. Application Data
(60) Provisional application No. 62/808,315, filed on Feb. 21, 2019.

(51) Int. Cl. B64D 13/02; B64D 15/04; B64D 13/08

(52) U.S. Cl. CPC B64D 13/02; B64D 2013/0611; B64D 13/08; B64D 15/04

(57) ABSTRACT

A system that allows using a fuel cell air compressor for cabin pressurization, cabin heat, and wing de-icing. One of the fuel cell's primary components, the compressor produces the pressure necessary to operate. The operating pressure is much higher than necessary for cabin pressurization so bleed air can be used for this purpose. Compressing air requires a lot of energy, and much of that energy is transferred into the air being compressed. This warm, compressed air could then be used to heat up the passenger cabin. Similarly the warm compressed air produced from the fuel cell compressor can be used to inflate the pouches on the leading edges of the wings to remove ice in the event of extreme weather. A control system is provided to operate each individual system. These systems will require control over multiple lines and valves, and will be registering feedback from pressure sensors mounted at each point. The onboard computer system will monitor user inputs and control outputs corresponding to each system.

### CROSS-REFERENCE TO RELATED PATENT APPLICATION

This regular U.S. patent application relies upon and claims the benefit of priority from U.S. provisional patent application No. 62/808,315, entitled “USING A FUEL CELL AIR COMPRESSOR FOR CABIN PRESSURIZATION, CABIN HEAT, AND WING DE-ICING,” filed on Feb. 21, 2019, which is incorporated by reference herein in its entirety.

### BACKGROUND OF THE INVENTION

### Field of the Invention

The disclosed embodiments relate in general to clean energy based air transportation systems technology, and, more specifically, to advanced FuelCell integration into aircraft.

### Description of the Related Art

While the fundamental theory and application of using Hydrogen Fuel Cells to power Electrically Driven aircraft is proven and established, there remain many challenges and optimizations of the specific integrations applicable to the various configurations of aircraft designs. Just like existing conventionally powered aircraft designs, the mechanical, electronic, fluidic, and thermal systems need to be properly engineered and integrated for optimum power, efficiency, safety, and physical characteristics including the aerodynamic, gravimetric, and volumetric packaging of the system. Currently existing integrations of Fuel Cell systems do not properly address the design requirements of the aviation industry.

### SUMMARY OF THE INVENTION

The inventive methodology is directed to methods and systems that substantially obviate one or more of the above and other problems associated with conventional technology.

In accordance with one aspect of the embodiments described herein, there is provided a system that allows using a fuel cell air compressor for cabin pressurization, the system comprising a compressor that produces the pressure necessary to operation of a fuel cell, wherein bleed air from the compressor is used for cabin pressurization.

In accordance with one aspect of the embodiments described herein, there is provided a system that allows using a fuel cell air compressor for cabin heat, the system comprising a compressor that produces the pressure necessary to operation of a fuel cell, wherein heat produced by the air compressor is used for cabin heat.

In accordance with one aspect of the embodiments described herein, there is provided a system that allows using a fuel cell air compressor for aircraft deicing, the system comprising a compressor that produces the pressure necessary to operation of a fuel cell, wherein warm air produced by the air compressor is used for aircraft de-icing.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIGS. 1-5 depict various possible embodiments of the invention.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

Because of the increased efficiency and different energy flows of a fuel cell electric system, there is less waste heat and pressurized air from the drivetrain available for other uses in the aircraft. Examples include Cabin Pressurization and Heating and De-Icing equipment.

Because of the lower operating temperatures of the Fuel Cell Stack and drivetrain components, the Delta-T of the associated cooling systems is much lower than conventional drive systems, requiring greater cooling capacity(?) to achieve cooling requirements. Existing air induction, and liquid cooling systems and radiators will not be sufficient for H2 FC cooling requirements.

Because of the lower total fuel energy densities(capacities?) available with H2 FC systems, low aerodynamic drag and low energy loss cooling systems are even more critical than in conventional aircraft designs. Minimal air induction and cooling path aerodynamic drag is a requirement.

Because Fuel Cell Electric Powertrains are generally comprised of a multitude of smaller components, and are generally more modular as compared to their conventional powertrain(powerplant) analogs, we propose these new and novel solutions to these new and existing problems of aircraft drivetrain implementations.

Using a Compressor's Bleed Air for Cabin Pressurization

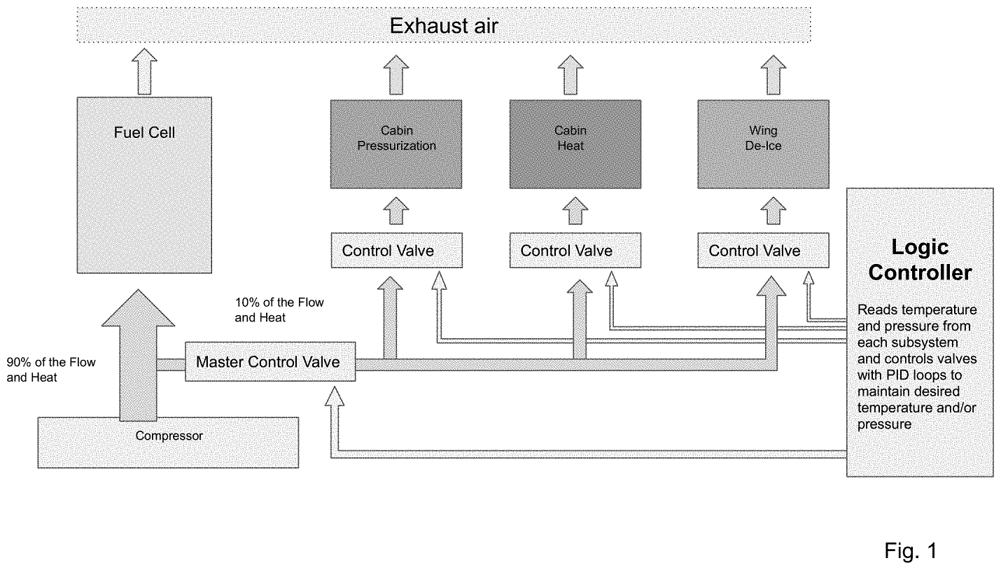

One of the Fuel Cell's primary components, the Intake Air Compressor produces the pressure necessary to operate. The operating pressure is much higher than necessary for cabin pressurization so bleed air from the compressor can be used for this purpose. See FIG. 1.

Using the Heat Generated from Compressing Air and Waste Heat to Provide Cabin Heat

Compressing air requires a lot of energy, and much of that energy is transferred into the air being compressed. This warm, compressed air could then be used to heat up the passenger cabin. Waste heat from hi and low temperature cooling loops can also be used for this purpose. See FIG. 1.

Using a Compressor's Bleed Air to Rapidly Inflate De-Icing Pouches

Similar to the above claims, the warm compressed air produced from the fuel cell compressor can be used to inflate the pouches on the leading edges of the wings to remove ice in the event of extreme weather. See FIG. 1.

Control System for Compressor Bleed Air System

The inventive claims described above will require a control system to operate each individual system. These systems will require control over multiple lines and valves, and will be registering feedback from pressure sensors mounted at each point. The onboard computer system will monitor user inputs and control outputs corresponding to each system. See FIG. 1.

Use cowling, wings, and other external surfaces with large airflows as heat dissipation devices for FC system cooling

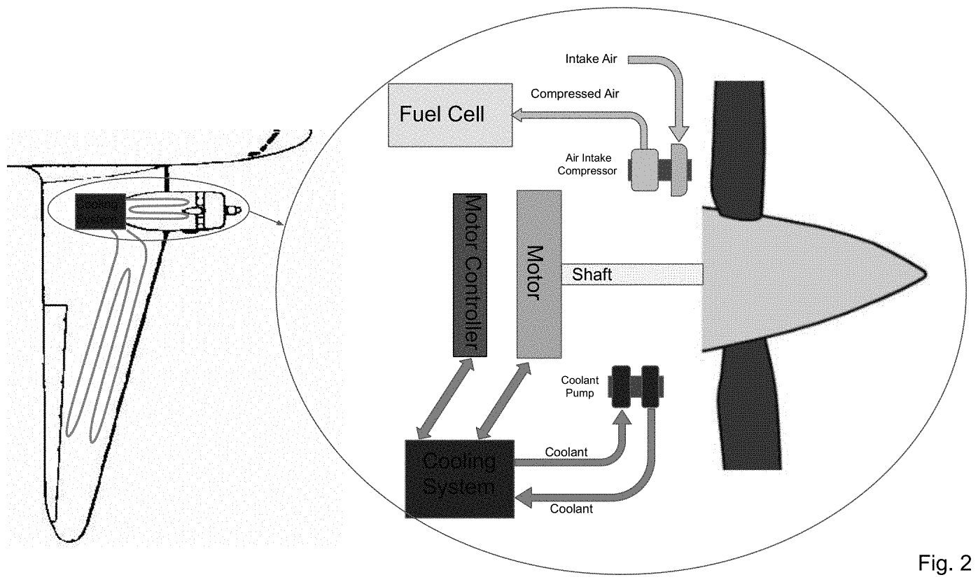

To keep aerodynamic drag to a minimum, it would be beneficial to use existing external surfaces for cooling surface area, which would allow for increased cooling capacity with no additional drag penalty. See FIG. 2.

Heat Pumps to Increase Temperature Differentials for Improved Heat Rejection

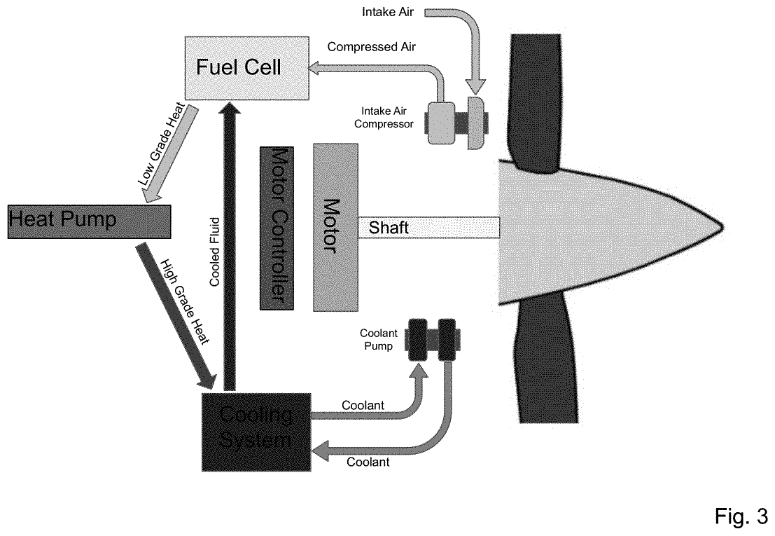

By increasing the Temperature Differential (Delta-T) of the cooling medium to ambient temperature, the cooling capacity for a given interface surface area is increased. This means for a small increase in required cooling system power, the associated air induction and radiator systems can be much more effective at transferring heat which means they can be smaller resulting in less aerodynamic drag and weight which yields a net benefit in vehicle efficiency. See FIG. 3.

Heat Pipes to More Efficiently Transfer Heat

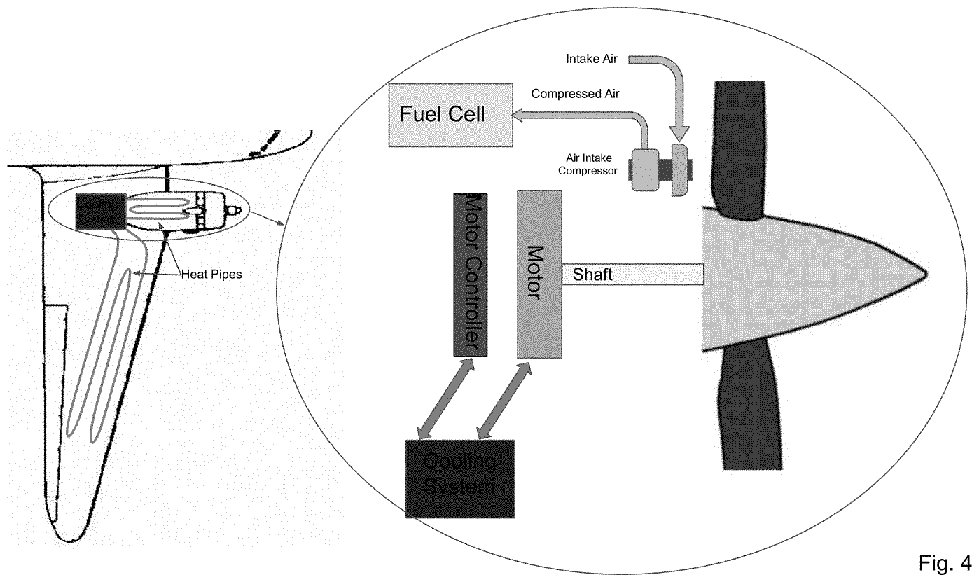

A heat pipe is a heat-transfer device that combines the principles of both thermal conductivity and phase transition to effectively transfer heat between two solid interfaces. Because it requires no external power it can be a very efficient heat transfer medium, resulting in overall increased energy efficiency for the vehicle. See FIG. 4.

Use Phase Change Materials to Buffer Heat Output of Fuel Cell Powertrain

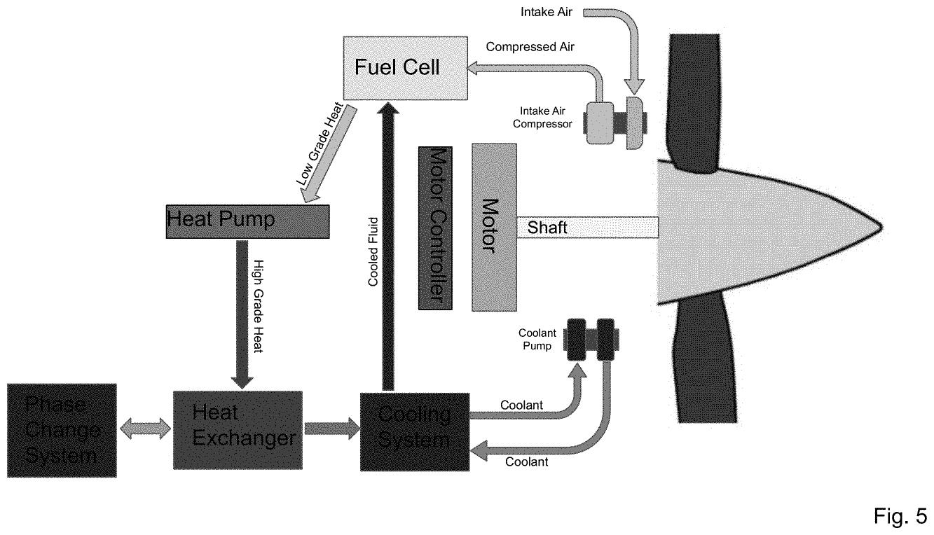

Invention uses phase change materials (water, paraffin, etc . . . ) that require a high amount of energy for the phase change to buffer the heat output of the FC, such as during the takeoff. See FIG. 5.

Details:

Small aircraft are generally equipped with a cabin heater, the heat is generated by the onboard engine. When running, the engine's exhaust operates at temperatures close to 800 degrees fahrenheit. Ambient air is introduced from outside and passed over the exhaust pipes of the engine or a heat exchanger and then piped into the cabin.

In an aircraft propelled with electric motors, there is no exhaust manifold, and the motors operate at much lower temperatures, thus a new method of providing cabin heat is required.

For a Fuel Cell powered Electric aircraft there is heat available in the Fuel Cell stack cooling loop. This heat can be obtained through a heat exchanger in-line with the cooling loop.

For pure battery electric aircraft, this heat can be obtained through a heat exchanger in-line with the motor/controller liquid cooling loop.

Aircraft can also be equipped with wing de-icing systems for safety reasons. This system operates by inflating a pouch on the leading edge of each wing. The pouch is inflated via air fed in from the turbocharger's wastegate similar to the cabin pressure mechanism. These pouches must be inflated quickly and then deflated quickly to knock ice off the wings. Deflation is done via a vacuum pump separate from engine operation.

As with the cabin pressure mechanism, electric motors do not require a turbocharger, and thus the method to inflate the de-icing pouches must be replaced. ZeroAvia plans to replace the internal combustion engines in small airplanes with electric motors. As such, an electrically driven compressor will provide the means to accomplish wing de-icing.

The system to control the flow of air to each sub-system, shown in FIG. 1, will include a two stage pressure and temperature valve control system. The first stage controls the amount of compressed heated air diverted to the sub-systems. The first stage master valve can be closed to restrict all airflow to the subsystems if it is desired for safety reasons. This valve is controlled by a logic controller implementing a PID loop or similar control strategy to keep the pressure and temperature at optimal levels to supply the sub-systems.

Each sub-system is supplied by a secondary valve controlled by a logic controller which controls the desired temperature and pressure for each sub system independently.

Liquid cooling pipes or heat pumps are thermally connected to the insides of exposed aircraft surfaces to take advantage of the external airflow for cooling purposes. The liquid cooling pipes or heat pipes are bonded to the inside of the surface with a thermally conductive adhesive, or built into the structure itself when fabricated. Thermally conductive fluid such as water or glycol is run through the piping. The fluid pump is driven by electric or mechanical means. The heat can be also used for de-icing of the surfaces, such as wings and tail stabilizers during flight. Can be used also for heating of various A/C sensors.

Typical H2 PEM Fuel Cells run the high temperature cooling loop below 100 C, which means that the delta-T to the ambient air temperature is much lower than that of a combustion engine, making heat rejection harder. The invention is to insert a high-efficiency heat pump between the FC cooling loop and the external radiator/heat exchanger to move the heat from below 100 C to significantly above 100 C for better rejection velocity. Like an AC cycle in reverse but with higher temp coolant. Output of the Heat Pump should be 150-200 C.

Heat pumps are now common components in modern EV's such as the Nissan Leaf, BMW i3 EV, I-Pace, Audi E-tron, Toyota Prius Prime, Volkswagen e-Golf, etc.

One implementation is to insert a high-surface-area enclosure filled with paraffin into the coolant loop of the FC. For example to run the coolant through a heat exchanger enclosed in a volume of phase change material. If the phase transition temperature of the working substance (paraffin) is chosen in the operating range of the FC, a large amount of energy can be removed from the fuel cell by melting the substance during the high-power operation when the main cooling system does not have enough capacity to remove all the heat at the required rate.

Can be used in conjunction with claim 6 to modify temperatures and increase phase change materials options.

Invention can be open or closed loop. Open loop, just 10 l of water converted to steam dissipates 6.2 kWh of energy, or approx 100 kW for 6 minutes. This means we can turn 10-20 l of water into steam and use approx ˜½ the normal cooling system size otherwise required.

Thermal management system regulates the following components:

Fuel Cell Stack

Intake Air

Motor

Motor Controller

H2 Tanks

H2 Plumbing

Cabin Heat and Pressurization

De-Icing equipment

Selectively Heat or Cool Aerodynamic Surface to Locally Control Air Temperature and Resulting Aerodynamic Qualities/Effects

With the large amounts of heating and cooling capacity available with an FC system, it is possible to locally change the temperature of the external air adjacent to the surfaces of the aircraft. This would have a similar effect as different ambient temperatures and their effect on altitude density and Reynold Number.

Using the “cold loop” available using a heat exchanger from H2 storage. For cabin air conditioning. Or maybe even pre-chilling motor/controller? and or providing additional cooling capacity? Should we reference cryo and superconducting motors and systems?

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in aircraft power plants. It is intended that the specification and examples be considered as exemplary only, with a true scope and spirit of the invention being indicated by the following claims.

What is claimed is:

1. A system that allows using a fuel cell air compressor for cabin pressurization, the system comprising a compressor that produces the pressure necessary to operation of a fuel cell, wherein bleed air from the compressor is used for cabin pressurization.

2. A system that allows using a fuel cell air compressor for cabin heat, the system comprising a compressor that produces the pressure necessary to operation of a fuel cell, wherein heat produced by the air compressor is used for cabin heat.

3. A system that allows using a fuel cell air compressor for aircraft deicing, the system comprising a compressor that produces the pressure necessary to operation of a fuel cell, wherein warm air produced by the air compressor is used for aircraft de-icing.
